(19) United States
(12) Patent Application Publication
(10) Pub. No.: US 2018/0339562 A1
(43) Pub. Date: Nov. 29, 2018

(54) RAPID CLIPPER FOR INFLATING TIRE

(71) Applicant: Hsu-Ming LIU, Zhuhai City (CN)

(72) Inventor: Hsu-Ming LIU, Zhuhai City (CN)

(21) Appl. No.: 15/979,489

(22) Filed: May 15, 2018

(30) Foreign Application Priority Data
May 25, 2017 (CN) 201710379634.6

(51) Int. Cl. B60C 29/06; F16L 37/02

(52) U.S. Cl. CPC B60C 29/06; F16L 37/02

(57) ABSTRACT

A rapid clipper for air inlet clipper comprises: an air inlet connector, an air inlet clipper, a first control member and an elastic member; the air inlet clipper includes a main body, formed with a first end and a second end, and a clipping member, and includes a passageway and at least one cut groove; the clipping member is inside the cut groove and capable of being reciprocally moved along the cut groove, and the middle portion of the clipping member is protruded into the passageway so as to be latched with an outer thread of a tire valve nozzle; the first control member is moveably disposed in the air inlet clipper and formed with an accommodation slot, when the first control member is axially moved along the air inlet clipper, the location where the clipping member being disposed in the cut groove is able to be altered.

### BACKGROUND OF THE INVENTION

### 1. Field of the Invention

The present invention relates to an inflating device, especially to a rapid clipper for inflating tire.

### 2. Description of Related Art

Tires are one of the most important components in a vehicle, which may affect the performance of the vehicle and the drive safety. A valve nozzle is disposed in the inner tube or a tire for inflating or deflating the inner tube. A conventional inflating clipper is a pushing-type clipper. A distal end of the above-mentioned clipper is disposed with a one-way valve mechanism, when being inflated, the clipper is served to propel (or buckle) the tire nozzle, a propel pin inside the clipper is abutted against an elastic propel pin inside a valve core, so that the above two are served to open the valve at the same time for the purpose of inflating. The interior of the inflating clipper is disposed with a clipping member used for being fastened with the valve nozzle, but the conventional means of utilizing the clipping member of the inflating clipper for allowing the clipping member to propel the valve nozzle is complicated in operation, labor consuming and provided with an poor airtightness effect.

### SUMMARY OF THE INVENTION

In view of the above-mentioned disadvantages, one technical solution provided by the present invention is to provide a rapid clipper for inflating tire having advantages of rapid in connection, easy to be operated and having an excellent airtightness effect.

Accordingly, the present invention provides a rapid clipper for inflating tire, which comprises: an air inlet connector, used for being connected to an air inlet pipe; an air inlet clipper, including a main body and a clipping member, wherein the main body is formed with a first end and a second end and includes a passageway and at least one cut groove, the passageway is axially penetrated the main body, a tire valve nozzle is allowed to pass the first end of the main body and inserted into the passageway, and the air inlet connector is allowed to pass the second end of the main body and inserted into the passageway so as to be fastened with the main body; the middle portion of the cut groove is communicated with the passageway, the clipping member is accommodated inside the cut groove and capable of being reciprocally moved along the cut groove, two ends of the clipping member are protruded out from the cut groove, and the middle portion of the clipping member is protruded into the passageway so as to be latched and connected to an outer thread of the tire valve nozzle; and further comprises: a first control member, moveably disposed at the exterior of the air inlet clipper, the first control member is formed with an accommodation slot used for accommodating the two ends of the clipping member, when the first control member is axially moved along the air inlet clipper, the location where the clipping member being disposed in the cut groove is able to be altered; and an elastic member, one end of the elastic member is abutted against one end of the first control member, another end thereof is abutted against the air inlet connector; before the tire valve nozzle is connected to the rapid clipper for inflating tire, the elastic member is stretched for driving the first control member to be in a first working position, the first control member is abutted against the clipping member, the clipping member is located at the inner end of the cut groove; after the tire valve nozzle is connected to the rapid clipper for inflating tire, the elastic member is in a compressed status, the first control member is in a second working position for driving the clipping member to tightly clip the tire valve nozzle.

According to one preferred embodiment of the present invention, the cut groove is inclined towards the first end of the main body alone an inclined surface of the thread of the outer thread of the tire valve nozzle, and the inclined angle of the cut groove of the air inlet clipper is the same as the inclined angle of the outer thread of the tire valve nozzle.

According to one preferred embodiment of the present invention, the first control member is a round disk pad, which is formed in a sleeve-like status and sleeved at the outer periphery of the air inlet clipper; and the elastic member is a compression spring.

According to one preferred embodiment of the present invention, the rapid clipper for inflating tire further comprises a second control member, the second control member is moveably disposed at the exterior of the air inlet clipper, abutted against another end of the first control member opposite to the elastic member, thereby allowing the location of the first control member to be altered.

According to one preferred embodiment of the present invention, the second control member is formed in a sleeve-like status and sleeved on the outer circumference of the air inlet clipper, and the second control member is a moveable sleeve; the above-mentioned round disk pad is disposed between the moveable sleeve and the air inlet clipper, and the moveable sleeve is formed with an abutting part abutted against another end of the round disk pad relative to the elastic member; and a pressure generated by the moveable sleeve is able to be directly applied to the elastic member via the round disk pad.

According to one preferred embodiment of the present invention, there are two cut grooves disposed on the main body, the clipping member is formed as a latch rod, there are two latch rods and two accommodation slots of the first control member respectively and correspondingly arranged, and the two cut grooves are oppositely arranged;

before the tire valve nozzle is connected to the rapid clipper for inflating tire, the elastic member is stretched for driving the round disk pad to be in the first working position, the round disk pad is abutted against the two latch rods, the two latch rods are both located at the inner end of the cut groove; after the tire valve nozzle is connected to the rapid clipper for inflating tire, the elastic member is in a compressed status, the round disk pad is in the second working position, the distance between the two latch rods is greater than or equal to the inner diameter of the outer thread of the tire valve nozzle, but smaller than the outer diameter of the outer thread of the tire valve nozzle, and the two latch rods are served to tightly clip the tire valve nozzle; when the tire valve nozzle is released from the rapid clipper for inflating tire, the moveable sleeve and the round disk pad are downwardly pressed, the round disk pad is in a third working position, the compression spring is in a further compressed status, the two latch rods are continuously moved towards outward along the cut groove, the distance between the two latch rods is greater than the outer diameter of the outer thread of the tire valve nozzle, thereby allowing the tire valve nozzle to be released.

According to one preferred embodiment of the present invention, the two cut grooves of the main body are axially and staggeringly arranged along the main body, the staggering distance is the integer multiple of the half thread gap of the outer thread of the tire valve nozzle, so that the two latch rods can both be ensure of being latched and threaded with the outer thread of the tire valve nozzle.

According to one preferred embodiment of the present invention, the two ends of the clipping member are formed as a connection part, and the middle portion thereof is formed as a buckle part, the connection part is formed in a circular column shape, and the buckle part is formed with an edge corner part capable of being latched and treaded with the outer thread of the tire valve nozzle.

According to one preferred embodiment of the present invention, the buckle part is formed in a polygonal column shape, the columnar surface of the polygonal column is formed with the cut slot allowing the thread of the outer thread of the tire valve nozzle to be accommodated, edges of the polygonal column are protruded into the gaps between the thread.

According to one preferred embodiment of the present invention, the accommodation slot of the first control member is formed with a bottom surface, a first inclined surface and a second inclined surface which are parallel to each other, and the clipping member is in contact with the first inclined surface, the second inclined surface and the bottom surface, and the inclined direction of the first inclined surface is opposite to the inclined direction of the cut groove.

According to one preferred embodiment of the present invention, the accommodation slot of the first control member is formed with a bottom surface and a first inclined surface, the clipping member is in contact with the first inclined surface and the bottom surface, and the inclined direction of the first inclined surface is opposite to the inclined direction of the cut groove; the bottom surface is parallel to the radial plane of the air inlet clipper.

According to one preferred embodiment of the present invention, the above-mentioned accommodation slot is further formed with a second lateral surface, and the second lateral surface is arranged to be vertical to the bottom surface.

Accordingly, with the rapid clipper for inflating tire provided by the present invention, the tire valve nozzle can be directly inserted into the air inlet clipper, thereby achieving an objective of rapid connection; the clipping member is connected to the elastic member via the first control member, the inclined slot of the first control member is able to form a force-saving inclined pushing status, so that a small force is required for overcoming the pushing force of the elastic member applied to the clipping member, thereby allowing the tire valve nozzle to be released; and the clipping force of the clipping member buckling the tire valve nozzle can be increased, thereby ensuring there is no gas leaking while the tire being inflated.

### BRIEF DESCRIPTION OF THE DRAWINGS

FIG. 1 is an exploded view showing the rapid clipper for inflating tire according to the present invention:

FIG. 2 is a front view of FIG. 1;

FIG. 3 is a cross sectional view showing the rapid clipper for inflating tire according to the present invention:

FIG. 4 is a schematic view showing the internal structure of the rapid clipper for inflating tire according to the present invention:

FIG. 5 is a schematic view showing the rapid clipper for inflating tire working with the tire valve nozzle, wherein the tire valve nozzle being in a buckled status, according to the present invention:

FIG. 6 is an enlarged view showing the location A of FIG. 5, wherein the clipping member being latched with the thread of the outer thread of the tire valve nozzle;

FIG. 7 is an enlarged view showing the location B of FIG. 5, wherein the two clipping members being staggeringly arranged;

FIG. 8 is a schematic view showing the rapid clipper for inflating working with the tire valve nozzle, wherein the tire valve nozzle being in a released status, according to the present invention:

FIG. 9 is a schematic view showing the clipping member being moved towards outward during the process of the tire valve nozzle being released as shown in FIG. 6;

FIG. 10 is a schematic view showing the clipping member being moved towards inward during the process of the tire valve nozzle being buckled as shown in FIG. 5;

FIG. 11 is an enlarged schematic showing the buckle part of the clipping member of the rapid clipper for inflating tire being in a polygonal column shape working with thread of the outer thread of the tire valve nozzle according to the present invention;

FIG. 12 is an enlarged schematic showing the buckle part of another clipping member of the rapid clipper for inflating tire being in a polygonal column shape working with thread of the outer thread of the tire valve nozzle according to the present invention;

FIG. 13 is a schematic view showing the force-saving inclined pushing device adopted in the rapid clipper for inflating tire according to the present invention;

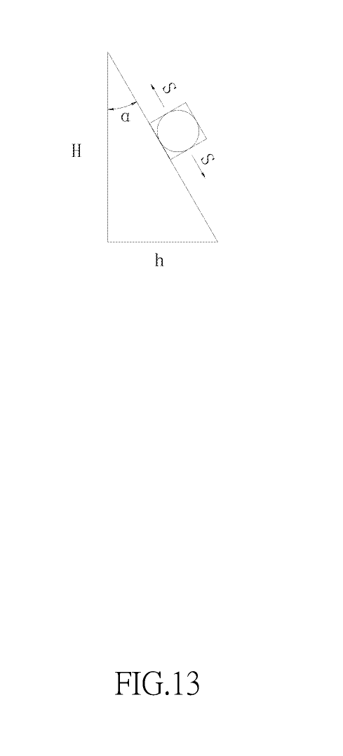

FIG. 14 is a schematic view showing the structure of a round disk pad adopted in the rapid clipper for inflating tire according to the present invention;

FIG. 15 is a schematic view showing the structure of another round disk pad adopted in the rapid clipper for inflating tire according to the present invention; and

FIG. 16 is a schematic view showing the structure of one another round disk pad adopted in the rapid clipper for inflating tire according to the present invention.

### DESCRIPTION OF CODES

100: Air inlet connector
200: Air inlet clipper
210: Main body
211: Passageway
212: Cut groove
220: Clipping member
221: Connection part
222: Buckle part
223: Edge corner part
223a, 223b, 223c: Edge corner part
300: Round disk pad
310: Inclined slot
310a, 310b, 310c: Accommodation slot
311a, 311b, 311c: First inclined surface
312a, 312b: Second inclined surface
313a, 313b, 313c: Bottom surface
400: Elastic member
500: Moveable sleeve
510: Abutting part
600: Anti-leaking pad
700: Tire valve nozzle
710: Outer thread
800: Latch ring

### DETAILED DESCRIPTION OF THE PREFERRED EMBODIMENT

Preferred embodiments of the present invention will be described with reference to the drawings. But what shall be addressed is that various embodiments are also within the scope of the present invention.

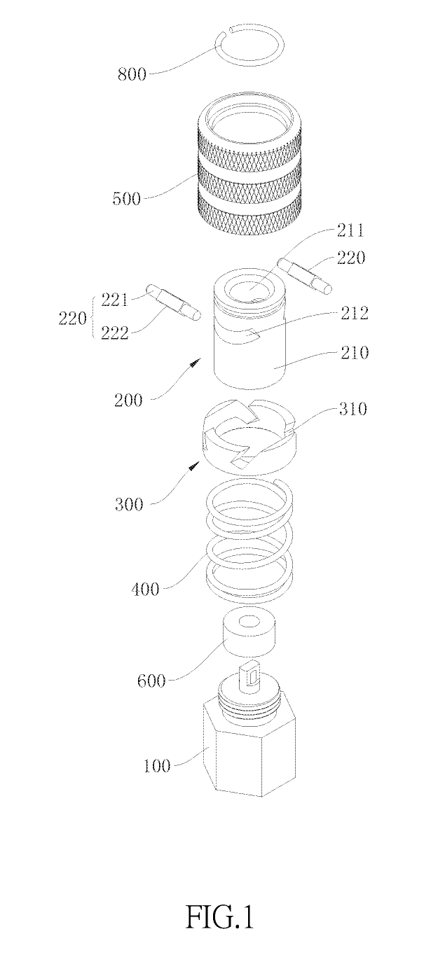

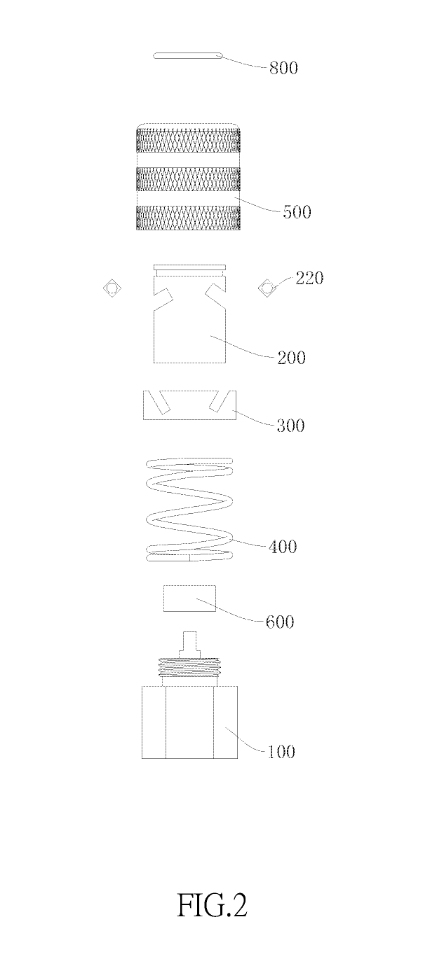

Please refer to FIG. 1 and FIG. 2, according to one preferred embodiment of the present invention, a rapid clipper for inflating tire comprising an air inlet connector 100, an air inlet clipper 200, a first control member and an elastic member 400 is provided. Wherein, the air inlet connector 100 is connected to an air inlet pipe (not shown in figures).

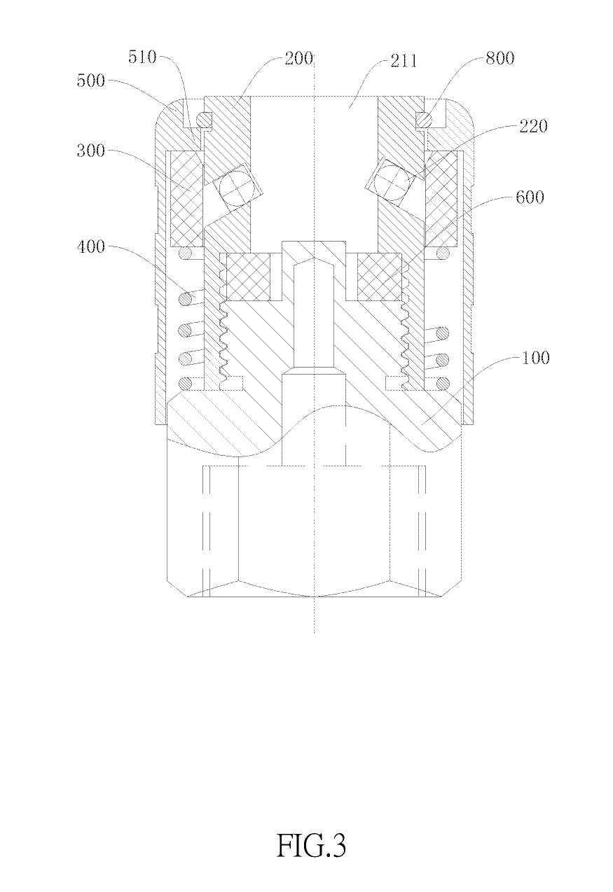

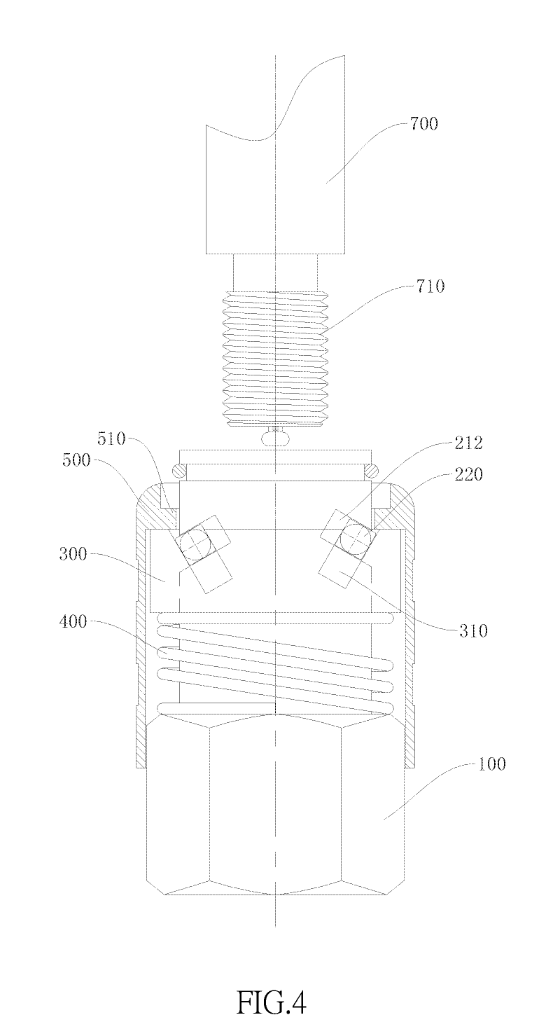

The air inlet clipper 200 includes a main body 201 and a clipping member 220, the main body 210 is formed with a first end and a second end, and includes a passageway 211 and at least one cut groove 212. The passageway 211 is axially penetrated the main body 210, as shown in FIG. 3 and FIG. 4, a tire valve nozzle 700 is allowed to pass the first end of the main body 210 and inserted into the passageway 211, and the air inlet connector 100 is allowed to pass the second end of the main body 210 and inserted into the passageway 211 so as to be threaded and fastened with the main body 210. Wherein, the cut groove 212 can be formed as a horizontal cut groove or can also be formed as an inclined cut groove, the inclined cut groove 212 is inclined from the second end of the main body 210 to the first end of the main body 210 and along an inclined surface of the thread of an outer thread 710 of the tire valve nozzle 700, and the inclined angle of the cut groove 212 of the air inlet clipper is the same as the inclined angle of the outer thread of the tire valve nozzle. The middle portion of the cut groove 212 is communicated with the passageway 211. The clipping member 220 is formed as a latch rod, accommodated inside the cut groove 212 and capable of being reciprocally moved along the cut groove 212, two ends of the clipping member 220 are protruded out from the cut groove 212, and the middle portion of the clipping member 220 is protruded into the passageway 211 so as to be latched and connected to the outer thread 710 of the tire valve nozzle 700.

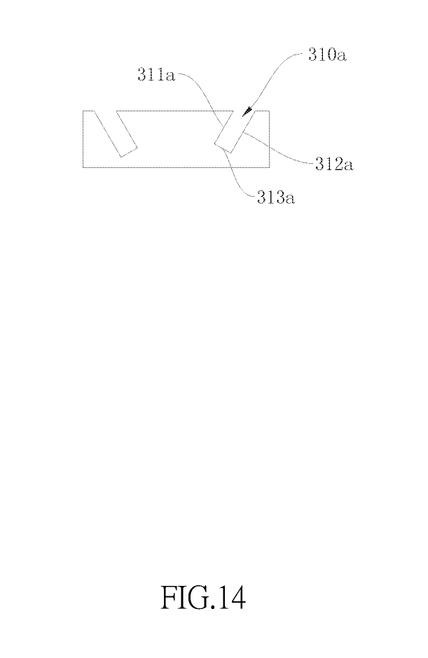

As shown in FIG. 3, the first control member is moveably disposed at the exterior of the air inlet clipper 200, substantially, the first control member is a round disk pad 300, which is formed in a sleeve-like status and sleeved at the outer periphery of the air inlet clipper 200. As shown in FIG. 1, FIG. 4 and FIG. 14, the round disk pad 300 is formed with an accommodation slot 310a used for accommodating the two ends of the clipping member 220, thereby allowing the location where the clipping member 220 being disposed in the cut groove 212 to be altered. Substantially, when the cut groove 212 is formed with the inclined cut groove, the accommodation slot is formed with a bottom surface 313a, a first inclined surface 311a and a second inclined surface 312a which are parallel to each other, and the two ends of the clipping member 220 are in contact with the first inclined surface 311a, the second inclined surface 312a and the bottom surface 313 a. The inclined direction of the first inclined surface 311a is opposite to the inclined direction of the cut groove 212.

One end of the elastic member 400 is abutted against one end of the round disk pad 300, another end thereof is abutted against the air inlet clipper 200; and a compression spring can be adopted as the elastic member 400.

According to the rapid clipper for inflating tire provided by the present invention, before the tire valve nozzle 700 is connected to the rapid clipper for inflating tire, the elastic member 400 is stretched for driving the first control member to be in a first working position, the first control member is abutted against the clipping member 220, the clipping member 220 is located at the inner end of the cut groove 212; after the tire valve nozzle 700 is connected to the rapid clipper for inflating tire, the elastic member 400 is in a compressed status, the first control member is in a second working position for driving the clipping member 220 to tightly clip the tire valve nozzle 700.

Furthermore, the rapid clipper for inflating tire further comprises a second control member, the second control member is moveably disposed in the air inlet clipper 200, abutted against another end of the round disk pad 300 opposite to the elastic member 400, thereby allowing the location of the round disk pad 300 to be altered. Substantially, the second control member is formed in a sleeve-like status and sleeved at the exterior of the air inlet clipper 200, and the second control member is a moveable sleeve 500. The round disk pad 300 is disposed between the moveable sleeve 500 and the air inlet clipper 200, and the moveable sleeve 500 is formed with an abutting part 510 abutted against another end of the round disk pad 300 relative to the elastic member, and a pressure generated by the moveable sleeve 500 is able to be directly applied to the elastic member 400 via the round disk pad 300.

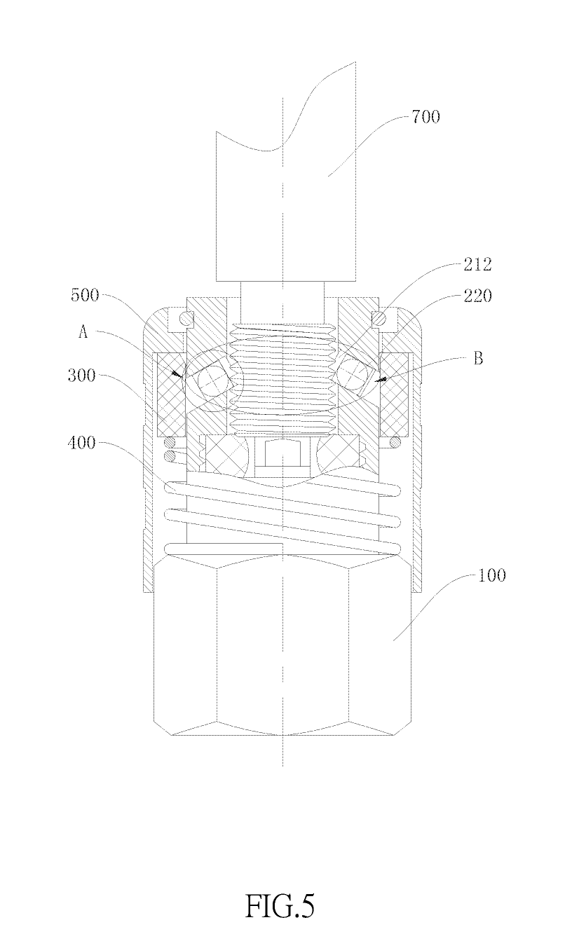

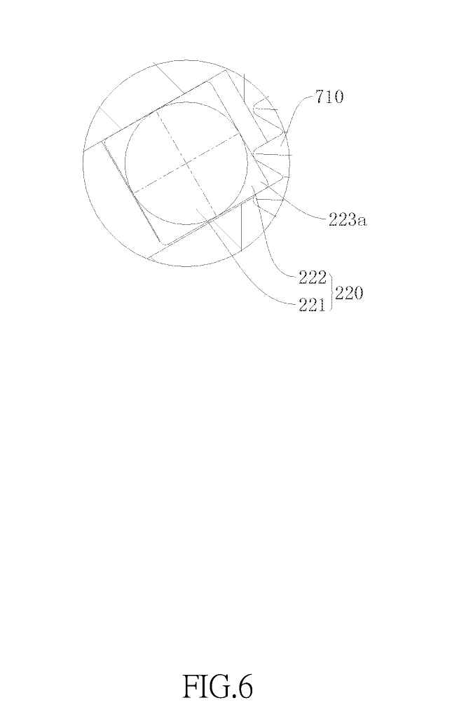

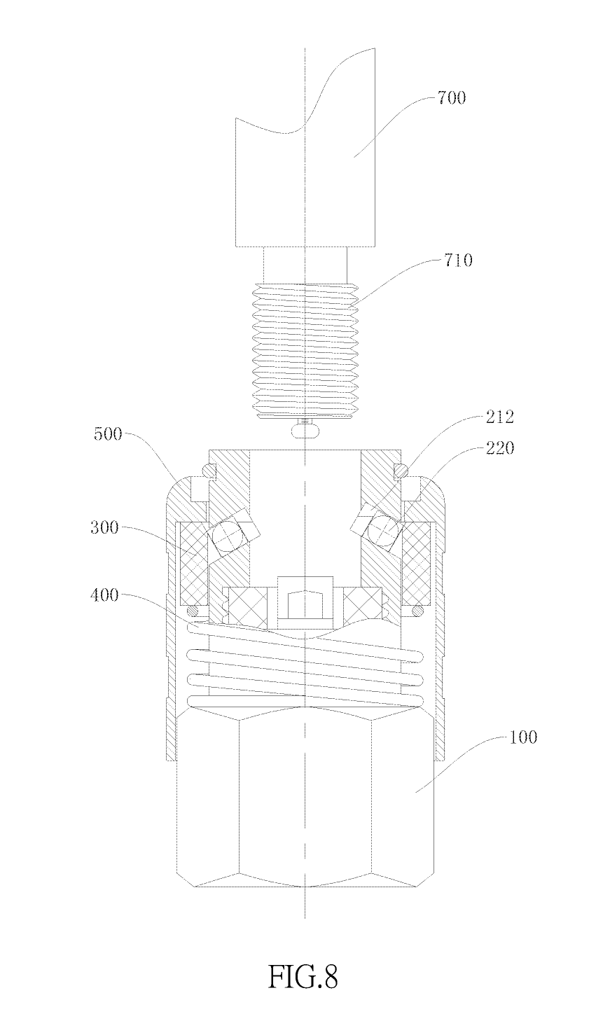

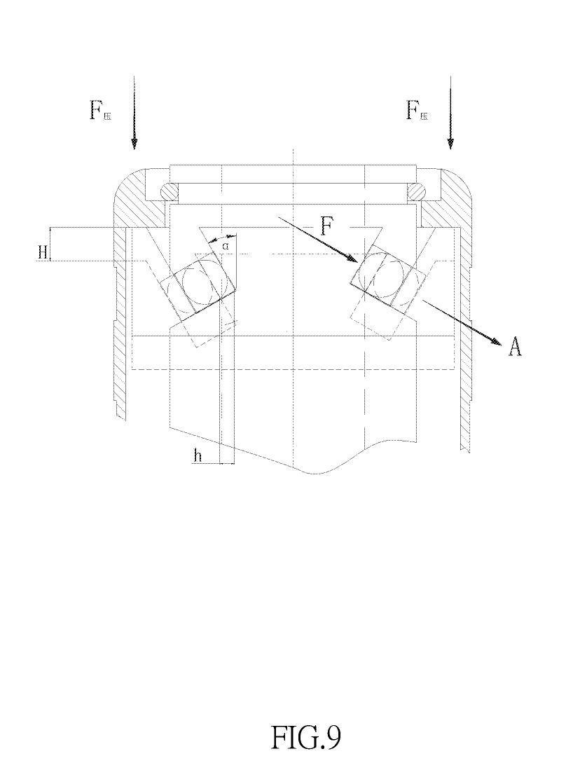

The operation process of the above-mentioned rapid clipper for inflating tire is illustrated as followings:
(1) when the tire is desired to be inflated and before the tire valve nozzle is connected to the rapid clipper for inflating tire, as shown in FIG. 4, the middle portion of the clipping member 220 inside the cut groove 212 of the air inlet clipper 200 is remained to be protruded into the passageway 211 of the air inlet clipper 200. The elastic member 400 is stretched for driving the round disk pad 300 to be in the first working position, the round disk pad 300 is abutted against the clipping member 220, and the clipping member 220 is located at the inner end of the cut groove 212. As shown in FIG. 5, when being inflated, the air inlet clipper 200 of the rapid clipper for inflating tire is pushed into the tire valve nozzle 700, as shown in FIG. 6, with the height difference between the thread top and the thread bottom of the outer thread 710 of the tire valve nozzle 700, when the middle portion of the clipping member 220 is moved from the thread bottom to the thread top, the clipping member 220 is pushed away by the thread, so that a pushing force applied for vertically pushing the air inlet clipper 200 is converted into a pushing force for pushing the clipping member 220 towards the outward direction along the inclined surface of the cut groove 212, at this moment the clipping member 220 is moved towards outward along the inclined surface of the cut groove 212, the two ends of the clipping member 220 are served to push the round disk pad 300 to be moved, so that the elastic member 400 can be further deformed by storing the elastic force. The air inlet clipper 200 is continuously to be pushed, the elastic member 400 is served to drive the round disk pad 300 to be moved towards a recovering direction, the clipping member 220 inside the inclined slot 310 of the round disk pad 300 is pushed by the round disk pad 300 for being moved towards inward along the inclined surface of the inclined slot, the middle portion of the clipping member 220 is latched between two threads, thereby allowing the tire valve nozzle 700 to be buckled. At this moment, the elastic member 400 is in a compressed status, the round disk pad 300 is in the second working position, the distance between the clipping member 220 and the central line of the tire valve nozzle is greater than or equal to the inner radius of the outer thread of the tire valve nozzle, but smaller than the outer radius of the outer thread of the tire valve nozzle, thereby allowing the clipping member 220 to tightly clip the tire valve nozzle. As such, after the reciprocal process of pushing and buckling, the tire valve nozzle 700 is able to propel an air inlet interface, and a valve nozzle core of the tire valve nozzle 700 is propelled to be opened, at this moment, with the clipping member 220 being pushed by the elastic member 400, the clipping member 220 is able to tightly buckle the tire valve nozzle 700, thereby forming a tire inflating status.
(2) when the tire inflating operation is finished and the tire valve nozzle 700 is desired to be released, as shown in FIG. 8 and FIG. 9, an applied force F is served to push the moveable sleeve 500 for altering the location of the round disk pad 300, so that the round disk pad 300 is in a third working position, and the elastic member 400 is in a further compressed status. At this moment, the round disk pad 300 is able to directly apply a force to the elastic member 400, and the clipping member 220 inside the inclined slot 310 is pushed and moved along the inclined surface of the inclined slot 310, meanwhile the axial displacement of the inclined slot 310 enables the clipping member 220 inside the cut groove 212 to be moved towards outward along the inclined surface of the cut groove 212, the distance between the clipping member and the central line of the tire valve nozzle is greater than the outer radius of the outer thread of the tire valve nozzle, thus the clipping member 220 is pushed towards outward, and the thread of the tire valve nozzle 700 is released, thereby allowing the tire valve nozzle 700 to be released.

Because the clipping member 220 is subjected to the pushing force of the elastic

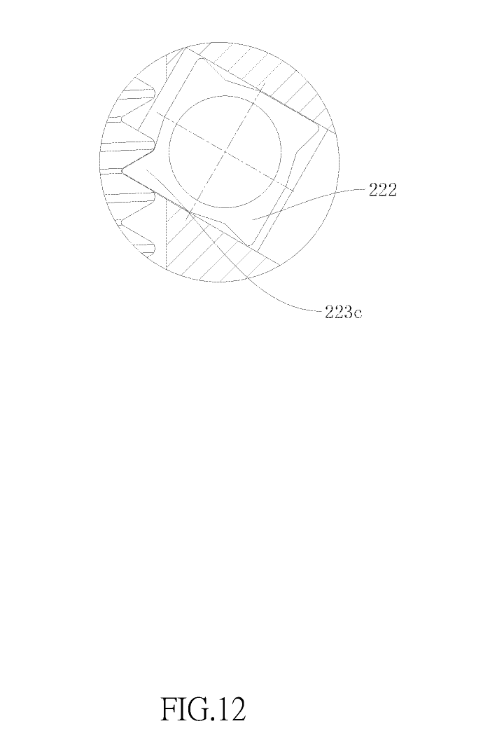

member 400, a greater force is required for releasing the tire valve nozzle 700. Please refer to FIG. 12, during the process of releasing the tire valve nozzle 700, when the clipping member 220 inside the inclined slot 310 is pushed and moved along the inclined surface of the inclined slot 310, the inclined slot 310 is formed as a force-saving inclined pushing device (the force required for pushing a weight for being upwardly moved along the inclined surface is smaller than the force required for vertically lifting the weight, and the smaller the included angle between the inclined surface and the horizontal plane, the less force required for lifting the weight), as shown from FIG. 9 and FIG. 12, an H is defined as the moving distance of the round disk pad 300, a h is defined as the distance of the clipping member 220 being horizontally moved towards inward, an S is defined as the distance of the clipping member 220 being moved along the inclined surface, an α is defined as the inclined angle of the force-saving inclined surface of the inclined slot 310. Because the action of the force-saving inclined pushing device, a smaller force is required to be applied to the moveable sleeve 500 for overcoming the pushing force of the elastic member 400 applied to clipping member 220 (an arrow A shown in FIG. 9 being defined as the moving direction of the clipping member 220), thereby allowing the tire valve nozzle 700 to be released.

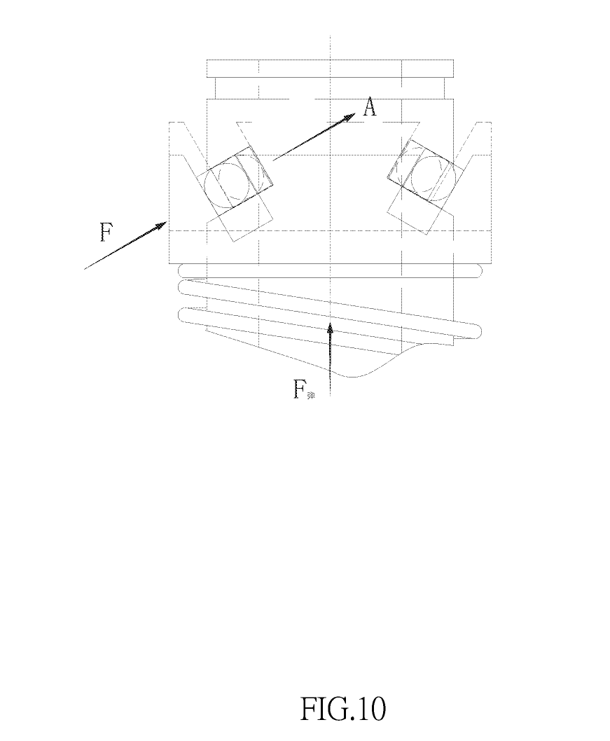

On the other hand, when the tire is desired to be inflated, the process of inserting the tire valve nozzle 700 into the air inlet clipper 200 requires a less force, and when the clipping member 220 is served to buckle the outer thread 710 of the tire valve nozzle 700, the force-saving inclined pushing device allows the deviation loss of the vertical pushing force F of the elastic member 400 to be smaller as shown in FIG. 10, so that the clipping force of the clipping member 220 buckling the tire valve nozzle 700 can be increased, thereby ensuring there is no gas leaking while the tire being inflated.

According to the rapid clipper for inflating tire provided by the present invention, the clipping member 200 is allowed to pass the round disk pad 300 so as to be connected to the elastic member 400, the inclined slot 310 of the round disk pad 300 forms a force-saving inclined pushing status, so that a small force is required for overcoming the pushing force of the elastic member 400 applied to the clipping member 220, thereby allowing the tire valve nozzle 700 to be released; and the clipping force of the clipping member 220 buckling the tire valve nozzle 700 can be increased, thereby ensuring there is no gas leaking while the tire being inflated.

When the above-mentioned cut groove 212 is a horizontal groove, the displacement process of the inclined slot 310 of the round disk pad 300 is able to form a force-saving inclined pushing status, when the cut groove is formed as an inclined groove, the inclined surface of the cut groove is also able to form a force-saving inclined pushing status, so that a less force is loss, and a small force is required for overcoming the pushing force of the elastic member 400 applied to the clipping member 220, thereby allowing the tire valve nozzle 700 to be released.

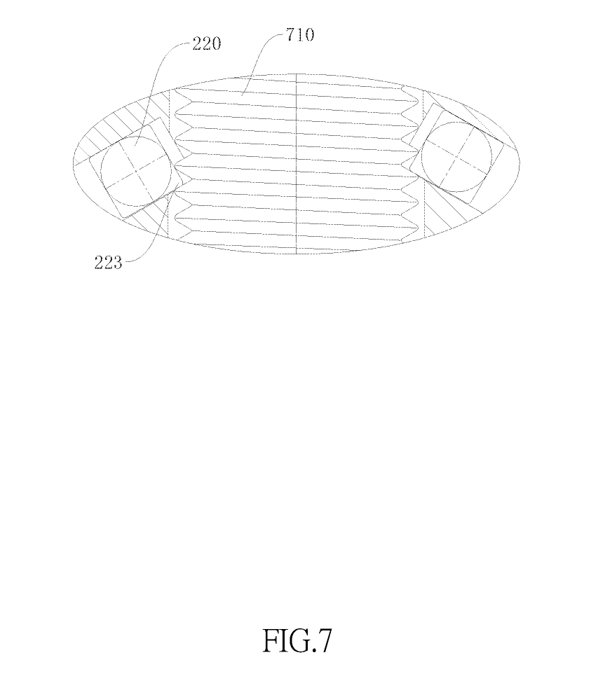

According to one preferred embodiment and as shown in FIG. 7, there are two cut grooves 212 disposed on the main body 210, and there are two clipping members 220 and two inclined slots 310 of the round disk pad 300 respectively and correspondingly arranged. According to other preferred embodiments, a plurality of the clipping members 220 can be adopted, and the plural clipping members 220 are evenly distributed along the circumferential direction of the air inlet clipper 200, so that the clipping force for buckling the tire valve nozzle 700 can be correspondingly increased. As shown in FIG. 10, the two clipping members 220 are arranged and served to clip the tire valve nozzle 700, the two cut grooves 212 are oppositely formed, and staggeringly arranged along the axial direction of the main body 210, the two clipping members 220 are also staggeringly arranged, so that the two clipping members 220 can be latched and connected to the outer thread 710 of the tire valve nozzle 700 at the same time. The round disk pad 300 is in the first working position, the round disk pad 300 is abutted against the two clipping members 220, and the two clipping members 220 are both located at the inner end of the above-mentioned cut groove. The round disk pad 300 is in the second working position, the distance between the two clipping members 220 is greater than or equal to the inner diameter of the outer thread of the tire valve nozzle, but smaller than the outer diameter of the outer thread of the tire valve nozzle, and the two latch rods are served to tightly clip the tire valve nozzle. The round disk pad 300 is in the third working position, the compression spring is in a further compressed status, the two clipping members 220 are continuously moved towards outward along the cut groove, the distance between the two clipping members 220 is greater than the outer diameter of the outer thread of the tire valve nozzle, thereby allowing the tire valve nozzle to be released. Substantially, because one round of the thread of the tire valve nozzle 700 is 360 degrees which is defined as a thread gap, half round of 180 degrees is defined as a half thread gap, when the two clipping members 220 are symmetrically arranged, only one of the two clipping members 220 can be ensure of being latched and threaded with the thread of the tire valve nozzle 700, thus the two clipping members 220 are staggeringly arranged, as long as the staggering distance is the integer multiple of the half thread gap of the outer thread, the two clipping members 220 can both be ensure of being latched and threaded with the thread of the tire valve nozzle 700, at this moment the clipping force for buckling the tire valve nozzle 700 can be twice as much, thereby ensuring the airtightness during the inflation operation, Meanwhile, the outer thread 710 of the tire valve nozzle 700 can be protected from being easily deformed, thereby preventing the thread from being damaged.

According to one preferred embodiment and as shown in FIG. 1 and FIG. 6, the two ends of the clipping member 220 are formed as a connection part 221, and the middle portion thereof is formed as a buckle part 222. Wherein, the connection part 221 is formed in a circular column shape, and the buckle part 222 is formed with an edge corner part 223 which can be latched and treaded with the thread of the outer thread 710 of the tire valve nozzle 700. Substantially, the buckle part 222 can be formed in a rectangular column shape. Right corner parts of the rectangular-column shaped buckle part 222 are defined as the edge corner parts 223a, one surface of the right corner part is arranged to be adjacent to the inclined surface of the thread, another surface thereof is abutted against the thread top.

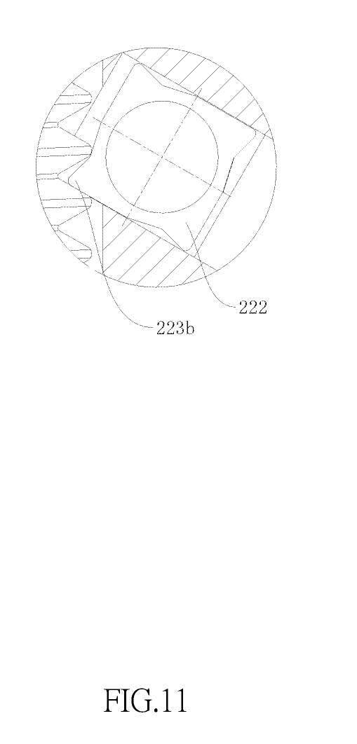

Furthermore, as shown in FIG. 11, the buckle part 222 can be formed in a polygonal column shape. The Columnar surface of the polygonal column is formed with the cut slot allowing the thread of the outer thread to be accommodated, edges of the polygonal column are protruded into the gaps between the threads so as to form the edge corner parts 223b. Or, right angle sides, which are adjacent to the thread surfaces, of the right corner parts of the rectangular column can be inwardly extended for forming the edge corner parts 233b. The polygonal-column shaped buckle part can increase the contact area with the inclined surface of the thread, thereby increasing the clipping force of the buckle part 222, meanwhile the thread can be prevented from being worn, and the thread can be protected from being deformed. As shown in FIG. 12, which is an alternative of the polygonal-column shaped buckle part, edges of the polygonal column are inwardly extended into the most bottom end defined between the threads so as to form an edge corner parts 223c, thereby further increasing the contact area with the inclined surface of the thread. What shall to be understood is that in the embodiment of the columnar surfaces of the polygonal column being formed with the cut slot, the cut slot can be formed on one columnar surface or can be correspondingly and symmetrically formed on a plurality of surfaces, thereby enabling the process to be easier. In the embodiment of the polygonal column formed through being inwardly extended, at least one right angle of the four angles of the rectangular column is inwardly extended, or a plurality of angles can be inwardly extended.

According to one preferred embodiment provided by the present invention, the rapid clipper for inflating tire further comprises an anti-leaking pad 600. The anti-leaking pad 600 is disposed at the end where the air inlet connector 100 being inserted into the air inlet clipper 200, and connected to the air inlet connector 100 and the main body 210 of the air inlet clipper 200 with a sealed means. The anti-leaking pad 600 is made of an elastic material, so that an airtight effect can be ensured, and when the anti-leaking pad 600 is pressed by the tire valve nozzle 700, the valve nozzle core of the tire valve nozzle 700 is propelled to be opened, at this moment the elastic force of the anti-leaking pad 600 and the elastic force of the elastic member 400 are both served to apply the pushing force to the round disk pad 300, thereby increasing the clipping force of the clipping member 220 buckling the tire valve nozzle 700.

According to another preferred embodiment provided by the present invention, the air inlet clipper 200 is disposed with a latch ring 800, which is used for restraining the moveable sleeve 500 from being released from the air inlet clipper 200, so that the round disk pad 300, the moveable sleeve 500 and the air inlet clipper 200 can be assembled as one piece. Substantially, the latch ring 800 is latched on the outer circumference at the first end of the air inlet clipper 200, arranged to be opposite to the abutting part 510 of the moveable sleeve 500, and served to perform a position limiting operation via blocking the abutting part 510.

According to one another preferred embodiment provided by the present invention, when the compression spring is adopted as the elastic member 400, because the end part of the compression spring is not a planar surface, for providing a better fitting with the end part of the compression spring and maintaining the stability while the round disk pad 300 being moved, the contact surface of the round disk pad 300 and the compression spring is formed as an inclined surface.

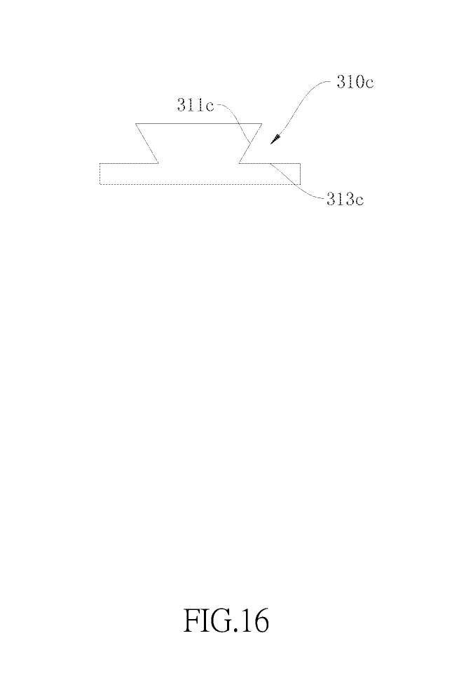

According to still one another preferred embodiment provided by the present invention and as shown in FIG. 16, which is a schematic view showing the structure of one another round disk pad 300, an accommodation slot 310c thereof includes a bottom surface 313c and a first inclined surface 311c. The clipping member 220 is in contact with the first inclined surface 311c and the bottom surface 313c. The inclined direction of the first inclined surface 311c is opposite to the inclined direction of the cut groove. The bottom surface 313c is parallel to the radial plane of the air inlet clipper.

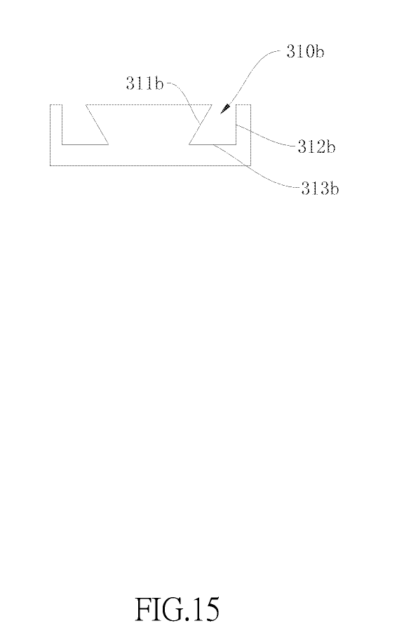

According to still one another preferred embodiment provided by the present invention and as shown in FIG. 15, which is a schematic view showing the structure of another round disk pad, an accommodation slot 310b thereof includes a first inclined surface 311b, a bottom surface 313b and a second lateral surface 312b. The second lateral surface 312b is arranged to be vertical to the bottom surface 313b.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific examples of the embodiments disclosed and that modifications and other embodiments are intended to be included within the scope of the appended claims. Although specific terms are employed herein, they are used in a generic and descriptive sense only and not for purposes of limitation.

What is claimed is:

1. A rapid clipper for inflating tire, comprising:
an air inlet connector, used for being connected to an air inlet pipe;
an air inlet clipper, including a main body and a clipping member, wherein the main body is formed with a first end and a second end and includes a passageway and at least one cut groove, the passageway is axially penetrated the main body, a tire valve nozzle is allowed to pass the first end of the main body and inserted into the passageway, and the air inlet connector is allowed to pass the second end of the main body and inserted into the passageway so as to be fastened with the main body; the middle portion of the cut groove is communicated with the passageway, the clipping member is accommodated inside the cut groove and capable of being reciprocally moved along the cut groove, two ends of the clipping member are protruded out from the cut groove, and the middle portion of the clipping member is protruded into the passageway so as to be latched and connected to an outer thread of the tire valve nozzle; and characterized in that: further comprising:
a first control member, moveably disposed at the exterior of the air inlet clipper, the first control member is formed with an accommodation slot used for accommodating the two ends of the clipping member, when the first control member is axially moved along the air inlet clipper, the location where the clipping member being disposed in the cut groove is able to be altered; and
an elastic member, wherein one end of the elastic member is abutted against one end of the first control member, another end thereof is abutted against the air inlet connector;
before the tire valve nozzle is connected to the rapid clipper for inflating tire, the elastic member is stretched for driving the first control member to be in a first working position, the first control member is abutted against the clipping member, the clipping member is located at the inner end of the cut groove; after the tire valve nozzle is connected to the rapid clipper for inflating tire, the elastic member is in a compressed status, the first control member is in a second working position for driving the clipping member to tightly clip the tire valve nozzle.

2. The rapid clipper for inflating tire as claimed in claim 1, wherein the cut groove is inclined towards the first end of the main body alone an inclined surface of the thread of the outer thread of the tire valve nozzle, and the inclined angle of the cut groove of the air inlet clipper is the same as the inclined angle of the outer thread of the tire valve nozzle.

3. The rapid clipper for inflating tire as claimed in claim 2, wherein the first control member is a round disk pad, which is formed in a sleeve-like status and sleeved at the outer periphery of the air inlet clipper; and the elastic member is a compression spring.

4. The rapid clipper for inflating tire as claimed in claim 3, further comprising a second control member, the second control member is moveably disposed at the exterior of the air inlet clipper, abutted against another end of the first control member opposite to the elastic member, thereby allowing the location of the first control member to be altered.

5. The rapid clipper for inflating tire as claimed in claim 4, wherein the second control member is formed in a sleeve-like status and sleeved on the outer circumference of the air inlet clipper, and the second control member is a moveable sleeve; the round disk pad is disposed between the moveable sleeve and the air inlet clipper, and the moveable sleeve is formed with an abutting part abutted against another end of the round disk pad relative to the elastic member; and a pressure generated by the moveable sleeve is able to be directly applied to the elastic member via the round disk pad.

6. The rapid clipper for inflating tire as claimed in claim 5, wherein there are two cut grooves disposed on the main body, the clipping member is formed as a latch rod, there are two latch rods and two accommodation slots of the first control member respectively and correspondingly arranged, and the two cut grooves are oppositely arranged; before the tire valve nozzle is connected to the rapid clipper for inflating tire, the elastic member is stretched for driving the round disk pad to be in the first working position, the round disk pad is abutted against the two latch rods, the two latch rods are both located at the inner end of the cut groove; after the tire valve nozzle is connected to the rapid clipper for inflating tire, the elastic member is in a compressed status, the round disk pad is in the second working position, the distance between the two latch rods is greater than or equal to the inner diameter of the outer thread of the tire valve nozzle, but smaller than the outer diameter of the outer thread of the tire valve nozzle, and the two latch rods are served to tightly clip the tire valve nozzle; when the tire valve nozzle is released from the rapid clipper for inflating tire, the moveable sleeve and the round disk pad are downwardly pressed, the round disk pad is in a third working position, the compression spring is in a further compressed status, the two latch rods are continuously moved towards outward along the cut groove, the distance between the two latch rods is greater than the outer diameter of the outer thread of the tire valve nozzle, thereby allowing the tire valve nozzle to be released.

7. The rapid clipper for inflating tire as claimed in claim 6, wherein the two cut grooves of the main body are axially and staggeringly arranged along the main body, the staggering distance is an integer multiple of the half thread gap of the outer thread of the tire valve nozzle, so that the two latch rods are both able to be latched and threaded with the outer thread of the tire valve nozzle.

8. The rapid clipper for inflating tire as claimed in claim 2, wherein the two ends of the clipping member are formed as a connection part, and the middle portion thereof is formed as a buckle part, the connection part is formed in a circular column shape, and the buckle part is formed with an edge corner part capable of being latched and treaded with the outer thread of the tire valve nozzle.

9. The rapid clipper for inflating tire as claimed in claim 8, wherein the buckle part is formed in a polygonal column shape, the columnar surface of the polygonal column is formed with a cut slot allowing the thread of the outer thread of the tire valve nozzle to be accommodated, edges of the polygonal column are protruded into the gaps between the thread.

10. The rapid clipper for inflating tire as claimed in claim 2, wherein the accommodation slot of the first control member is formed with a bottom surface, a first inclined surface and a second inclined surface which are parallel to each other, and the clipping member is in contact with the first inclined surface, the second inclined surface and the bottom surface, and the inclined direction of the first inclined surface is opposite to the inclined direction of the cut groove.

11. The rapid clipper for inflating tire as claimed in claim 10, wherein the accommodation slot of the first control member is formed with a bottom surface and a first inclined surface, the clipping member is in contact with the first inclined surface and the bottom surface, and the inclined direction of the first inclined surface is opposite to the inclined direction of the cut groove; the bottom surface is parallel to the radial plane of the air inlet clipper.

12. The rapid clipper for inflating tire as claimed in claim 11, wherein the above-mentioned accommodation slot is further formed with a second lateral surface, and the second lateral surface is arranged to be vertical to the bottom surface.
